(19) United States
(12) Patent Application Publication
(10) Pub. No.: US 2018/0233006 A1
(43) Pub. Date: Aug. 16, 2018

(54) APPARATUS, ELECTRICAL TERMINAL, AND PLUG ADAPTER FOR THE TERMINAL

(71) Applicant: Rosenberger Telematics GmbH, Timelkam (AT)

(72) Inventors: Thomas Koniarek, Schwanenstadt (AT); Christian Meschnig, Attersee (AT)

(21) Appl. No.: 15/751,135

(22) PCT Filed: Aug. 8, 2016
(86) PCT No.: PCT/EP2016/068917

§ 371 Date: Feb. 7, 2018

(30) Foreign Application Priority Data
Aug. 7, 2015 (EP) 15180317.8

(51) Int. Cl. G08B 13/14; B25F 5/00; H01R 13/639; H01R 24/68; H01R 31/06

(52) U.S. Cl. CPC G08B 13/1409; B25F 5/00; H01R 13/6397; G08B 21/0269; H01R 31/065; G08B 13/1427; H01R 24/68

(57) ABSTRACT

A plug adapter for preventing the theft of an electrical terminal, in particular a hand-held tool, that is connected to the plug adapter by means of its power plug, having a housing that constitutes a plug connector for plugging the plug adapter into an outlet of an electrical supply system and a socket that is electrically connected to the plug connector for plugging in the power plug of the terminal, having a monitoring device provided in the housing for detecting the theft of the terminal and having a connection securing device of the plug adapter. The connection securing device produces a non-detachable connection between the socket and the power plug of the terminal in order to affix the power plug to the plug adapter and the monitoring device has both a rechargeable electrical energy storage device and a telematics device.

### FIELD OF THE INVENTION

The invention relates to a plug adapter for preventing the theft of an electrical terminal—in particular a hand-held tool—that is connected to the plug adapter by means of its power plug, having a housing that constitutes a plug connector for plugging the plug adapter into an outlet of an electrical supply system, in particular a low-voltage system, and a socket that is^{,} electrically connected to the plug connector for plugging in the power plug of the terminal, having a monitoring device provided in the housing for detecting the theft of the terminal, and having a connection securing device of the plug adapter.

### BACKGROUND OF THE INVENTION

in order to produce a theft prevention device for electrical terminals, the prior art (U.S. Pat. No. 4,121,201A) has disclosed connecting the terminal to the electrical supply system by means of a plug adapter. The plug adapter in this case has a power plug for plugging into an outlet of the electrical supply system and a socket for accommodating the power plug of the terminal so that a monitoring device in the plug adapter can discover an unplugging of the terminal and in this regard, an alarm can be triggered. So that the plug adapter cannot be unplugged from the outlet of the electrical supply system, a connection securing device is provided, which is affixed to the outlet of the electrical supply system by means of a detachable screw connection. Plug adapters of this kind are in fact conceivable for stationary electrical terminals but not with electrical hand-held tools, whose operation requires frequent plugging into and unplugging from a wide variety of sockets of the electrical supply system.

### SUMMARY OF THE INVENTION

The stated object of the invention, therefore, is to improve a theft prevention device for an electrical terminal that is connected to it such that a theft can be reliably detected but without restricting the operability of the terminal.

The invention attains the stated object in that the connection securing device produces a non-detachable, in particular form-fitting, connection between the socket and the power plug of the terminal in order to affix the power plug to the plug adapter and in that the monitoring device has both a rechargeable electrical energy storage device for providing it with an emergency power supply, which energy storage device can preferably be charged via the plug of the plug adapter that can be connected to the electrical supply system, and a telematics device designed to track the position of the plug adapter in order to distinguish between theft and proper use of the terminal as a function of the positioning data of the telematics device when the plug adapter is disconnected from the electrical supply system.

If the connection securing device produces a non-detachable, in particular form-fitting, connection between the socket and the power plug of the terminal in order to affix the power plug to the plug adapter, then the plug adapter forms a structural unit that is connected to the terminal in a particularly durable way—which not only yields a reliable theft protection, but also advantageously does not entail any restriction of the operation of the terminal. An uninterrupted, continuous theft protection can be assured if in addition, the monitoring device has both a rechargeable electrical energy storage device for providing it with an emergency power supply, which energy storage device can preferably be charged via the plug of the plug adapter that can be connected to the electrical supply system, and a telematics device designed to track the position of the plug adapter in order to distinguish between theft and proper use of the terminal as a function of the positioning data of the telematics device when the plug adapter is disconnected from the electrical supply. In this context, the electrical energy storage device can ensure that even after an interruption in the connection to the electrical supply system—for example due to an unplugging of the plug adapter or due to a power outage—the power supply to the telematics device is maintained. In such cases, the electrical energy storage device can be recharged by means of a corresponding electrical charging circuit in the plug adapter after the connection to the electrical supply system is reestablished. After an interruption of the connection of the plug adapter to the electrical supply system, the telematics device of the plug adapter serves to determine whether this interruption has occurred as part of proper use of the terminal or whether it is an interruption connected with a theft. This can take place based on the positioning data recorded by the telematics device. According to the invention, it is thus possible to produce a plug adapter that does not restrict the operability of the terminal and can also reliably detect a theft.

In general, it should be noted that distinguishing between proper use and theft based on positioning data can be carried out in that a theft is identified as having occurred for example when a preset physical boundary is exceeded. It would also be conceivable to detect the movement speed based on the positioning data and to classify this movement as theft when a certain movement speed is exceeded. It is also noted in general that for example, electrical construction equipment, terminals, rotary hammers, drills, mixing machines, etc. can all be covered by the term “electrical terminal.” It is also generally noted that the “power plug” of the electrical terminal can be understood to be an electrical connection at the lowest level of a low-voltage system.

If the non-detachable connection between socket and power plug is composed of a snap connection between two housing parts of the housing, then the non-detachable connection between the plug adapter and the electrical terminal can be produced in a structurally simple way. In addition, this can yield an easy to operate and handle plug adapter.

For example, the protection of the plug adapter from spraying water can be increased if the housing has a seal for producing a sealed connection to the power plug of the terminal.

If the seal that can be connected to the power plug is provided on the housing parts of the housing, then it is possible to simplify the design of the plug adapter. This is particularly true if this seal is positioned in the region of the outer edge of the respective housing parts.

If the plug adapter is embodied as essentially cylindrical and ends in a plug connector and a socket that are at opposite ends from each other, then it is possible to achieve an extremely compact plug adapter for preventing the theft of an electrical hand-held device. In particular, the compact design of the plug adapter can feature the fact that it does not impede the use of the electrical hand-held device.

The theft prevention can be further improved if the monitoring device is positioned in the housing between the plug connector and the socket. According to the invention, it is thus possible to eliminate the use of additional devices and modules and to achieve a more compact plug adapter that is particularly reliable in its function. This can also serve to ensure that the monitoring device cannot be detached from the electrical hand-held device—which enables an uninterrupted monitoring of the hand-held device.

The monitoring device can be protected from environmental influences in a structurally simple way if this monitoring device is encapsulated in the housing. This can be achieved, for example, with the monitoring device being cast into the housing.

If the monitoring device has a circuit board with openings that permit a possible penetration by—and production of an electrical and/or inductive connection with—the contact pins of the power plug of the terminal, then the plug adapter can be designed in an extremely simple way, using few components. In addition, this can enable an extremely compact design of the plug adapter.

If the monitoring device has a measuring device for measuring the impedance of the cable of the terminal that is connected to the power plug in its switched-off operating mode, then the theft prevention device can be further improved and embodied in a more reliable way. For example, the impedance measurement of the hand-held tool can be used to monitor whether the electrical connection between the plug adapter and the terminal is interrupted—for example due to the connecting cable of the terminal being cut. The impedance measurement can even take place if the connecting plug is not connected to the electrical supply system at the moment, i.e. is being powered by the energy storage device.

The theft prevention of the plug adapter can be embodied in an even more reliable way if a differentiation between theft and proper use of the terminal is carried out based on a comparison of the positioning data of the telematics device to data regarding a predetermined maximum local movement range. It is thus possible to simply determine whether, for example, an interruption in the connection of the plug adapter to the electrical supply system has occurred as part of proper use of the hand-held device. In this context, the current positioning data can be respectively compared to predetermined coordinates, making it possible to determine whether the electrical hand-held device has left the permissible usage area—in order to trigger a theft alarm. This can significantly simplify the use of the plug adapter for theft prevention since when interruptions in the connection to the electrical supply system occur within the usage area, the user does not have to take any additional steps, for example in order to prevent the triggering of an alarm.

The telematics device can be embodied with a comparatively simple design if this telematics device has a transceiver module and in particular, has a satellite receiving module. It is possible to do without a satellite receiving module such as GPS if the transceiver module generates the positioning data, for example by means of triangulation.

The decision between theft and proper use of the terminal can, for example, take place separately from the plug adapter, which simplifies the design of the latter. To this end, the positioning data of the telematics device can be transmitted via the transceiver module, possibly along with monitoring data of the monitoring device, to a mobile terminal and/or to a server for comparison of the positioning data to data about the movement range. A mobile terminal such as a mobile phone can be particularly suitable for this. It is also conceivable to implement this by means of server services.

If the monitoring device has a lighting device for optically signaling the presence of the theft prevention device, not only can this act as a deterrent, but it is also easily possible to see on the plug adapter when the theft prevention is activated.

The plug adapter can be advantageously used in a terminal, in particular a hand held tool, having a power plug in order to be non-detachably connected to this power plug.

In particular, an apparatus which has a mobile terminal and/or server and an electrical terminal and which, by means of its telematics device of the plug adapter, has a data connection to the mobile terminal and/or server can constitute a theft prevention device for the electrical terminal that excels relative to other theft prevention devices with regard to its ease of use.

### BRIEF DESCRIPTION OF THE DRAWINGS

In the figures, the subject of the invention is depicted in greater detail by way of example based on an exemplary embodiment. In the drawings:

FIG. 1 shows a schematic sectional view of the plug adapter with the terminal connected,

FIG. 2 shows a detailed schematic sectional view of the plug adapter,

FIG. 3 shows an end view of the plug adapter,

FIG. 4 shows a schematic view of the monitoring device of the plug adapter depicted in FIG. 1, and

FIG. 5 is a depiction of a use of the plug adapter.

### DETAILED DESCRIPTION OF THE PREFERRED EMBODIMENTS

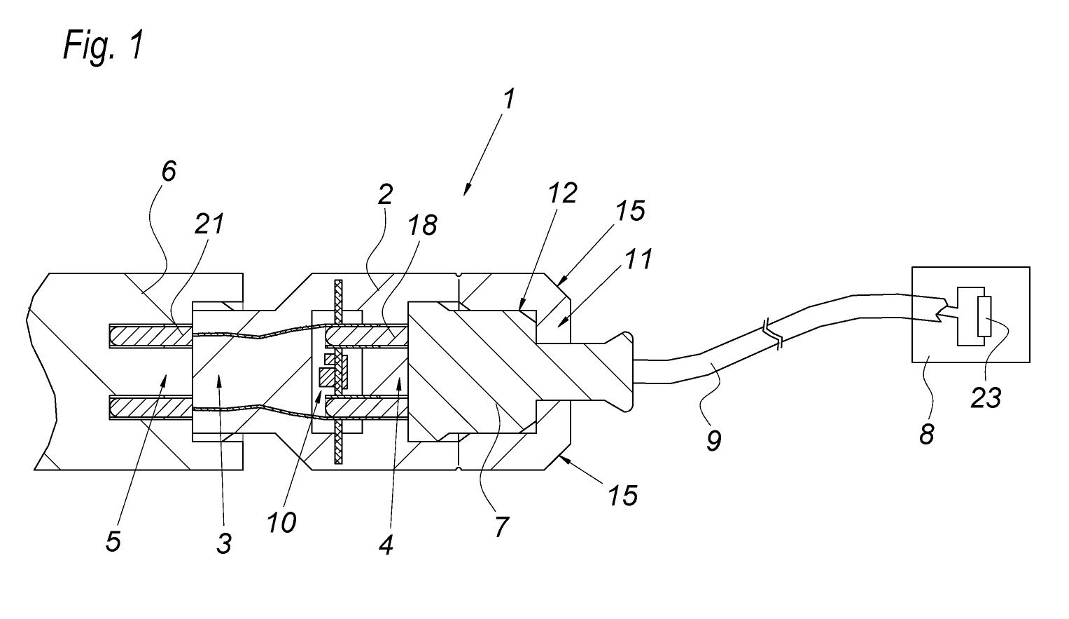

FIG. 1 shows a plug adapter 1, which has a housing 2. The housing 2 forms a plug 3 toward one end and a socket 4 toward the other end. The plug 3 in this case can be inserted in a corresponding outlet 5 of an electrical supply system 6 in order to supply the plug adapter 1 with electrical power. The socket 4 serves to accommodate a power plug 7 of an electrical terminal 8, which is only schematically depicted and which is connected to it via a connecting cable 9. One conceivable example of the electrical terminal 8 is a rotary hammer.

In general, it should be noted that in the exemplary embodiment of an electrical supply system 6, the low-voltage system has been described as having a line voltage of 230 V (single-phase), which is typical in Europe. To this end, the electrical terminal 8 has a power plug 7 that is an F-type plug (Schuko plug). It is also conceivable, but not shown in detail, for the plug adapter 1 to be embodied for connection to a three-phase low-voltage system and for the plug 3 and socket 4 of the plug adapter 1 to be embodied in accordance with the standard for industrial and multiphase plugs (IEC 60309).

The housing 2 of the plug adapter 1 also accommodates a monitoring device 10, which is suitable for detecting the theft of the terminal 8. The power plug 7 of the terminal 8 is also non-detachably connected to the housing 2 of the plug adapter 1 by means of a connection securing device 11 in order to prevent an unauthorized unplugging of the power plug 7 from the plug adapter 1. In order to produce the non-detachable connection 12 to the power plug 7, the connection securing device 11 produces a form-fitting engagement, which ensures a reliable hold of the power plug 7. The housing 2 of the plug adapter 1 also has a rechargeable energy storage device 13, in particular a capacitor or battery, which serves as an emergency power supply for the monitoring device 10. The energy storage device 13 in this case can be connected—for example via the plug 3—to the electrical supply system 6 in order to be recharged when a proper supply of energy is present. The housing 2 of the plug adapter 1 also contains a telematics device 14 as part of the theft prevention device 10 in order to distinguish between a theft and the proper use of the terminal 8 if there is an interruption in the electrical connection between the plug 3 of the plug adapter 1 and the outlet 5 of the electrical supply system 6.

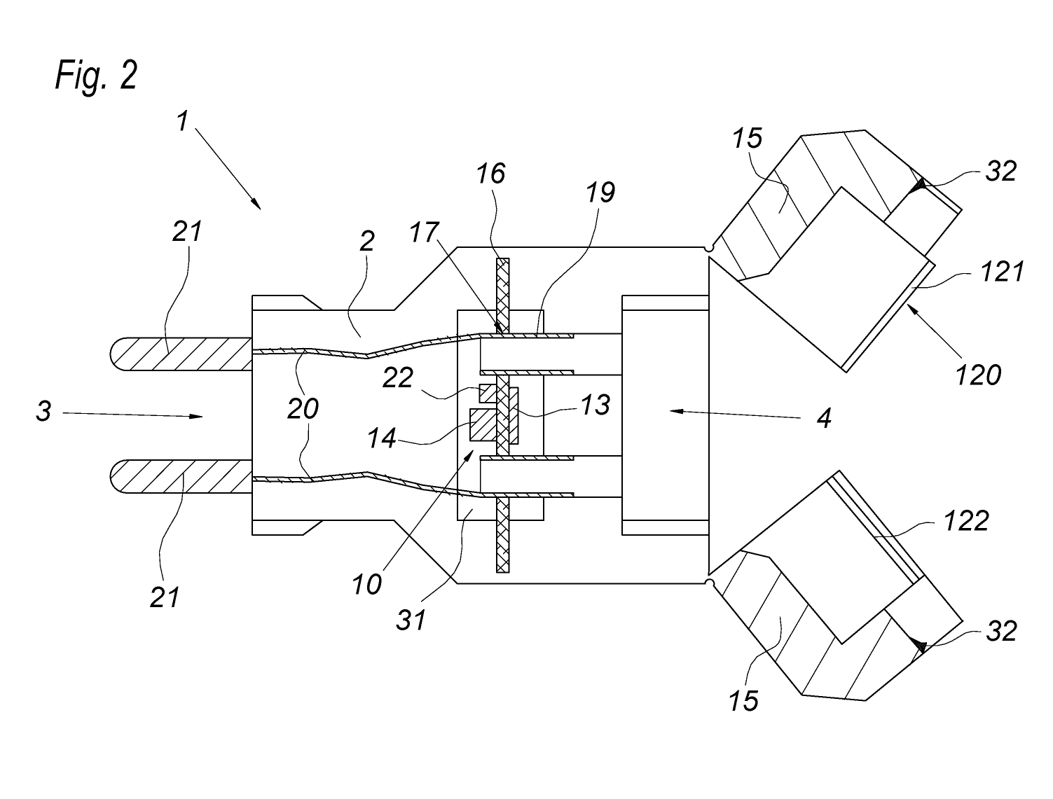

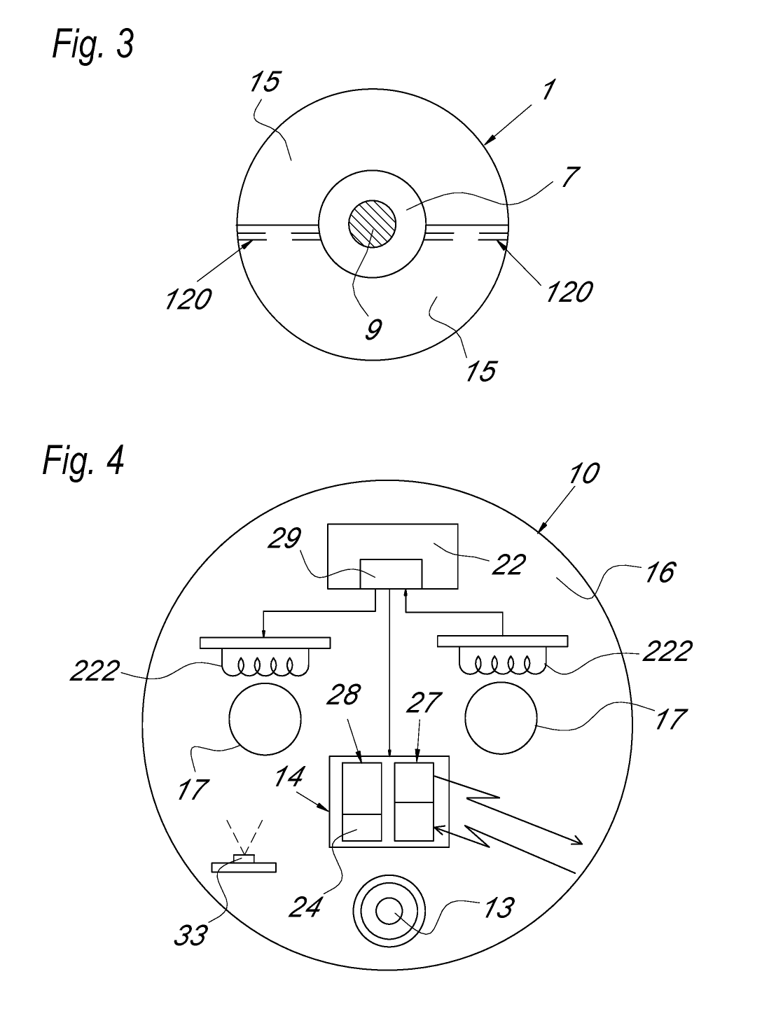

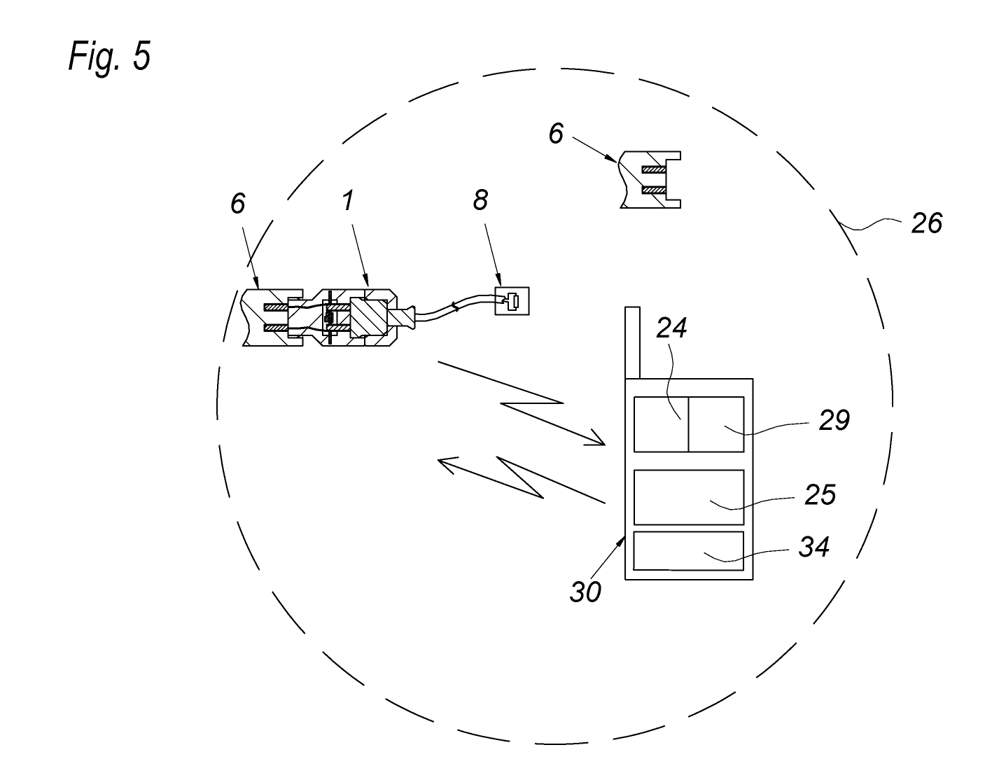

As depicted in FIG. 2, the non-detachable connection 12 between the power plug 7 of the terminal 8 and the socket 4 of the plug adapter 1 is embodied in the form of a snap connection 120 between two housing parts 15 of the housing 2. To this end, the snap connection 120 has a snap hook 121 as a snap element on one housing part 15 and a corresponding undercut 122 on the opposite housing part in which the snap hook can engage in detent fashion, as shown in FIGS. 2 and 3. The housing parts in this case are connected to the housing 2 by means of moving hinges 16 and can be folded in toward the middle in order to produce the non-detachable connection 12. In particular, the housing parts 15 are embodied as half shells. It is also conceivable, however, for the housing parts 15 to be embodied with any other division. When the housing parts 15 are folded in toward the middle of the plug adapter 1, this produces the non-detachable snap connection 120.

The housing 2 of the plug adapter 1 is particularly embodied as cylindrical and ends in a plug 3 at one end and in a socket 4 at the other. The monitoring device 10 in this case is accommodated inside the housing 2 between the plug 3 and the socket 4. This enables an extremely compact and short design of the plug adapter 1.

The monitoring device 10 also has a circuit board 16 in which openings 17 are provided for the contact pins 18 of the power plug 7 in order to thus electrically connect the power plug 7 of the terminal 8 to the circuit board 16 for purposes of monitoring the terminal 8. As is particularly clear in FIG. 1, the socket 4 has a contact sleeve 19 for this purpose extending through the opening 17 in order to ensure the electrical contact with the contact pins 18 of the power plug 7 and to produce the electrical or inductive connection to the circuit board 16.

The plug 3 and socket 4 of the plug adapter 1 are connected to each other electrically via two electrically parallel connecting lines 20, with the connecting lines 20 each connected to a contact pin 21 of the plug 3 and to a contact sleeve 19 of the socket 4.

Next to the telematics device 14, a measuring device 22 is also provided on the circuit board 16 in the monitoring device 10. This measuring device 22 is able to measure the impedance 23 of the terminal 8 that is connected to the circuit board 16 via the power plug 7 and the connecting cable 9. To this end, the measuring device 22 is associated with measurement coils 222, for example. The monitoring device 10 can therefore be used to determine whether the electrical connection between the plug adapter 1 and the electrical terminal 8 is interrupted, for example, by the connecting cable 9 being cut. This can be detected, for example, by a change in the impedance due to a time shift in an alternating signal used as a measuring signal. This information is stored, for example, in monitoring data 29.

Distinguishing between theft and proper use of the terminal 8 is also carried out based on the positioning data 24 of the telematics device 14, as is shown in detail particularly in FIG. 4. A maximum local movement range 26 within which the terminal 8 is permitted to move is predetermined. If the terminal 8 goes beyond this permitted movement range 26, then this constitutes a theft. It is therefore possible to distinguish between theft and proper use of the terminal 8 by comparing the positioning data 24 of the telematics device 14 to data 25 regarding a predetermined maximum local movement range 26.

The telematics device 14 shown in greater detail in FIG. 4 has a GSM transceiver module 27 and a GPS satellite receiving module 28 in order to generate the positioning data 24. This could, however, also be carried out in a known way by means of the GSM transceiver module 27.

The transceiver module 27 is used to transmit the positioning data 24 of the telematics device 14 together with monitoring data 29 of the monitoring device 10 to a mobile terminal 30 that has a data connection with the telematics device 14 for this purpose.

The mobile terminal 30 therefore has all of the necessary data to distinguish between an authorized movement and an unauthorized movement or theft. In a known way, this mobile terminal 30, which is embodied as a mobile phone, for example, can have a software application (app), which is not shown in detail and can significantly facilitate the operation of this theft prevention device according to the invention. A supplementary or alternative system design through the addition of servers, databases, etc. is conceivable, but has not been shown in detail.

In general, it is noted that in connection with a mobile terminal 30 and its own positioning data 34, it is also possible to link the data 25 regarding the predetermined maximum local movement range 26 to the position of the mobile terminal 30. It is thus possible to produce a dynamic movement range 26, which follows the movement of the mobile terminal 8. Thus the operation of the electrical terminal 8 can remain particularly simple despite the presence of the theft prevention device.

It is conceivable for an alarm or other notification about the theft of the electrical terminal 8 to be canceled or triggered by means of the mobile terminal 30 or also by means of the plug adapter 1.

The monitoring device 10 is encapsulated in the housing 2, as is shown in FIG. 2. To this end, after the monitoring device 10 has been inserted into the housing 2, a casting compound 31 is supplied.

The housing 2 also has a seal 32 for producing a sealed connection to the power plug of the terminal 8. This seal 32 is provided on the housing parts 15 of the housing 2. The encapsulated monitoring device 10 and/or the seal 32 ensure(s) an extremely high resistance to spraying water or water pressure-tightness.

In addition, a lighting device 33 such as an LED is provided on the plug adapter to optically signal, e.g. by means of a flashing light, the presence of the theft prevention device. This can be useful as an alarm or also as a deterrent.

1. A plug adapter for preventing the theft of an electrical terminal that is connected to the plug adapter by its power plug, the plug adapter comprising:
a housing that constitutes a plug connector for plugging the plug adapter into an outlet of an electrical supply system, and a socket that is electrically connected to the plug connector for plugging in the power plug of the terminal; and
a monitoring device provided in the housing for detecting a theft of the terminal and having a connection securing device of the plug adapter, wherein the connection securing device produces a non-detachable connection between the socket and the power plug of the terminal in order to affix the power plug to the plug adapter, and the monitoring device as both a rechargeable electrical energy storage device for providing the monitoring device with an emergency power supply, and a telematics device designed to track a position of the plug adapter in order to distinguish between theft and proper use of the terminal as a function of positioning data of the telematics device when the plug adapter is disconnected front the electrical supply system.

2. The plug adapter according to claim 1, wherein the non-detachable connection between the socket and the power plug is composed of a snap connection between two housing parts of the housing.

3. The plug adapter according to claim 2, wherein the housing has a seal for producing a sealed connection to the power plug of the terminal.

4. The plug adapter according to claim 2, wherein the seal that is connected to the power plug is provided on the housing parts of the housing.

5. The plug adapter according to claim 1, wherein the plug adapter is essentially cylindrical and ends in a plug connector and a socket, which are at opposite ends from each other.

6. The plug adapter according to claim 1, wherein the monitoring device is positioned in the housing between the plug connector and the socket.

7. The plug adapter according to claim 1, wherein the monitoring device is encapsulated in the housing.

8. The plug adapter according to claim 1, wherein the monitoring device has a circuit board with openings that permit a possible penetration by—and production of an electrical and/or inductive connection with—contact pins of the power plug of the terminal.

9. The plug adapter according to claim 1, wherein the monitoring device has a measuring device for measuring impedance of a cable of the terminal that is connected to the power plug in its switched-off operating mode.

10. The plug adapter according to claim 1, wherein a differentiation between theft and proper use of the terminal carried out based on a comparison of the positioning data of the telematics device to data regarding a predetermined maximum local movement range.

11. The plug adapter according to claim 1, wherein the telematics device has a transceiver module.

12. The plug adapter according to claim 11, wherein the positioning data of the telematics device are transmitted via the transceiver module, possibly along with monitoring data of the monitoring device, to a mobile terminal and/or to a server for comparison of the positioning data to data about a predetermined maximum local movement range.

13. The plug adapter according to claim 1, wherein the monitoring device has a lighting device for optically signaling a presence of the theft prevention.

14. An electrical terminal having a power plug and having a plug adapter according to claim 1 that is non-detachably connected to the power plug.

15. An apparatus, which has a mobile terminal and/or server and an electrical terminal according to claim 14, and which, by means of its telematics device of the plug adapter, has a data connection to the mobile terminal and/or server in order to constitute a theft prevention device for the electrical terminal.

16. The plug adapter according to claim 1, wherein the electrical terminal is a hand-held tool.

17. The plug adapter according to claim 1, wherein the electrical supply system is a low-voltage system.

18. The plug adapter according to claim 1, wherein the connection securing device produces a form-fitting connection between the socket and the power plug of the terminal.

19. The plug adapter according to claim 1, wherein the energy storage device can be charged via the plug connector of the plug adapter that can be connected to the electrical supply system.

20. The plug adapter according to claim 1, wherein the telematics device has a satellite receiving module.
